(19) United States
(12) Patent Application Publication
(10) Pub. No.: US 2012/0048184 A1
(43) Pub. Date: Mar. 1, 2012

(54) ORGANIC- INORGANIC HYBRID MATERIAL AND STAMP FOR NANOIMPRINT MANUFACTURED FROM THE SAME

(75) Inventors: Du-hyun Lee, Hwaseong-si (KR); Byung-kyu Lee, Seoul (KR); Woong Ko, Hwaseong-si (KR)

(73) Assignee: SAMSUNG ELECTRONICS CO., LTD., Suwon-si (KR)

(21) Appl. No.: 13/096,471

(22) Filed: Apr. 28, 2011

(30) Foreign Application Priority Data
Aug. 27, 2010 (KR) 10-2010-0083706

(51) Int. Cl. B29C 35/08; C08G 77/62; C08G 77/02; C08G 79/00; B05C 1/02; C08G 79/10

(52) U.S. Cl. 118/264; 264/496; 522/173; 522/172; 522/178

(57) ABSTRACT

Organic-inorganic hybrid materials may be inorganic-based materials including more inorganic material than organic material. The organic-inorganic hybrid materials may include a backbone material, a release material, and a photoinitiator. The backbone material may be formed of an inorganic material, and at least one of the release material and the photoinitiator may be formed of an organic material. The backbone material may include a compound (e.g., an oxide or a nitride) containing at least one selected from the group consisting of Si, In, Zn, Al, and Ti. The release material may include at least one selected from the group consisting of alkyl (CₙH₂ₙ₊₁), C, F, and Si.

### CROSS-REFERENCE TO RELATED APPLICATIONS

This application claims the benefit of Korean Patent Application No. 10-2010-0083706, filed on Aug. 27, 2010, in the Korean Intellectual Property Office, the entire disclosure of which is incorporated herein by reference.

### BACKGROUND

1. Field

Example embodiments relate to organic-inorganic hybrid materials and stamps for nanoimprinting made therefrom.

2. Description of the Related Art

A nanoimprinting process is a method of transferring fine patterns by pressing a resin layer on a substrate with a stamp having a fine pattern. The stamp may be repeatedly used, and an imprinting process may be relatively easily performed. Accordingly, the nanoimprinting operation has drawn attention as a next-generation lithography technology by which fine patterns may be economically and efficiently embodied.

Stamps for nanoimprinting of the related art are usually organic-based stamps containing an organic polymer as a main component, such as a polymethylsiloxane (PDMS) or perfluoropolyether (PFPE). However, since an elastic modulus of the organic-based material is as low as several MPa, patterns may easily collapse when a stamp having a fine pattern of about 30 nm or smaller is formed using the organic-based material. Also, if a molecular weight of the organic polymer is high, a precursor for the stamp including the organic polymer has a high viscosity, and thus, may not be easily filled in a mold for manufacturing the stamp, that is, in a fine groove (or hole) of a master mold.

In addition, the stamps of the related art need to be coated with a release layer so as to easily separate them from a resin layer to be patterned. Due to the release layer, durability of the stamps may be decreased and defects or pollution may be generated, and also controlling dimensions of patterns may be difficult. As described above, there are many limitations and difficulties in applying the organic-based materials as a stamp material for nanoimprinting.

### SUMMARY

Example embodiments provide organic-inorganic hybrid materials and stamps for nanoprinting manufactured from the same. The present invention also provides methods for manufacturing the stamps for nanoimprinting.

Additional aspects will be set forth in part in the description which follows and, in part, will be apparent from the description, or may be learned by practice of example embodiments.

According to an example embodiment, an organic-inorganic hybrid material including a backbone material made of an inorganic material, a release material and a photoinitiator, wherein at least one of the release material and the photoinitiator is formed of an organic material.

The inorganic material of the backbone material may be a compound including at least one selected from the group consisting of Si, In, Zn, Al, and Ti. The compound may be an oxide or a nitride. The release material may include at least one selected from the group consisting of alkyl (CₙH₂ₙ₊₁), C, F, and Si. The photoinitiator may include a material that provides ultraviolet (UV)-hardening characteristics to the organic-inorganic hybrid material.

The organic-inorganic hybrid material may be an inorganic-based material including more inorganic material than organic material. The organic-inorganic hybrid material may have a viscosity of about 500 cps or smaller.

According to another example embodiment, a stamp for nanoimprinting includes a fine concave-convex structure formed of the organic-inorganic hybrid material according to an example embodiment, and a supporting plate supporting the fine concave-convex structure.

The fine concave-convex structure may have an elastic modulus of about 0.5 GPa or greater, a water contact angle of about 90° or greater and an ultraviolet (UV) transmittance of about 60% or greater. The fine concave-convex structure may include a buffer layer and a pattern layer, and the buffer layer is between the supporting plate and the pattern layer.

According to another example embodiment, a method of manufacturing a stamp for nanoimprinting includes coating a master mold having a concave-convex shape with a precursor, the precursor including an organic-inorganic hybrid material having a backbone material made of an inorganic material, a release material and a photoinitiator, at least one of the release material and the photoinitiator being formed of an organic material, pressing the precursor with a supporting plate, forming a fine concave-convex structure including transferring the concave-convex shape of the master mold to the precursor, and hardening the precursor and separating the fine concave-convex structure attached to the supporting plate from the master mold.

The hardening the precursor may include exposing the precursor to UV rays.

### BRIEF DESCRIPTION OF THE DRAWINGS

These and/or other aspects will become apparent and more readily appreciated from the following description of example embodiments, taken in conjunction with the accompanying drawings of which:

FIGS. 1 through 4 are cross-sectional views illustrating a method of manufacturing a stamp for nanoimprinting, using an organic-inorganic hybrid material according to an example embodiment.

### DETAILED DESCRIPTION

Various example embodiments will now be described more fully with reference to the accompanying drawings in which example embodiments are shown.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In the drawings, the thicknesses of layers and regions are exaggerated for clarity. Like reference numerals in the drawings denote like elements.

Table 1 below shows components of an organic-inorganic hybrid material according to an example embodiment.

TABLE 1

| Backbone material | Release material | Photoinitiator |
|---|---|---|
| Inorganic compound | At least one | Free radical |
| (oxide or nitride) | selected from | initiator (Irgacure |
| including at least | the group con- | 184, Darocur 1173, |
| one selected from | sisting of alkyl, | etc.) |
| the group consisting | F, C, and Si | |
| of Si, In, Zn, Al, and Ti | | |

Referring to Table 1, the organic-inorganic hybrid material may include a backbone material, a release material, and a photoinitiator. The backbone material may be formed of an inorganic material. For example, the backbone material may be formed of an inorganic compound including at least one selected from the group consisting of silicon (Si), indium (In), zinc (Zn), aluminum (Al), and titanium (Ti). The inorganic compound may be an oxide or a nitride.

In other words, the backbone material may include an oxide or a nitride of one of Si, In, Zn, Al, and Ti. The backbone material may be included as a major component of the organic-inorganic hybrid material. In other words, the organic-inorganic hybrid material may be an inorganic-based material. Accordingly, stamps made from the organic-inorganic hybrid material may have a higher elastic modulus than stamps of the related art that are made from organic-based materials. The high elastic modulus of the organic-inorganic hybrid material indicates that the organic-inorganic hybrid material is more advantageous in realizing fine patterns than the organic-based material of the related art.

The release material may include an organic material such as alkyl (CₙH₂ₙ₊₁) or carbon (C), or an inorganic material such as fluorine (F) or silicon (Si). Due to the release material, the stamp made from the organic-inorganic hybrid material may have self-release characteristics. Accordingly, the stamp made from the organic-inorganic hybrid material does not need to be additionally coated with a release layer to facilitate separation from a resin layer. Thus, several problems related to the forming of the release layer, such as decrease in durability of the stamp, generation of defects and pollution, difficulty in controlling dimensions of the patterns, and the complexity of the process, may be prevented or reduced.

The photoinitiator may include a material that gives ultraviolet (UV) rays hardening characteristics to the organic-inorganic hybrid material. The photoinitiator may be a free radical initiator formed of an organic material. For example, “Irgacure 184” (1-hydroxycyclohexyl benzophenone) or “Darocur 1173” (2-hydroxy-2-methyl-1-phenylpropanone) available by Ciba Inc. may be used as the photoinitiator. The photoinitiator may be resolved by UV rays to cross-link molecules or atoms of the backbone material and the release material.

As such, since the organic-inorganic hybrid material is a UV-hardening material, there is no need for a heat hardening process when manufacturing a stamp. However, organic-based materials of the related art such as polydimethylsiloxane (PDMS) require a heat hardening process. In this case, patterns may deform due to a difference in thermal expansion coefficients of a master mold and a stamp. However, the organic-inorganic hybrid material according to an example embodiment is UV-hardening type material, and thus, problems related to heat hardening may be prevented or reduced.

In addition, the organic-inorganic hybrid material may have a viscosity of about 500 cps or lower, for example, about 10 cps or lower. When a polymer material having a relatively large molecular weight is used, a precursor for the stamp including the polymer material may have a higher viscosity and thus may not be easily filled in a fine groove (or hole) of a master mold. However, the organic-inorganic hybrid material according to an example embodiment has a relatively low viscosity as described above, and thus may be easily filled in the fine groove (or hole). In this respect, the organic-inorganic hybrid material may be advantageous in implementing fine patterns.

As described above, the organic-inorganic hybrid material according to an example embodiment has a high elastic modulus and self-release characteristics, and is a UV-hardening type complex having a relatively low viscosity. Thus, a stamp for nanoimprinting that has fine patterns and improved properties and characteristics may be formed using the organic-inorganic hybrid material according to an example embodiment.

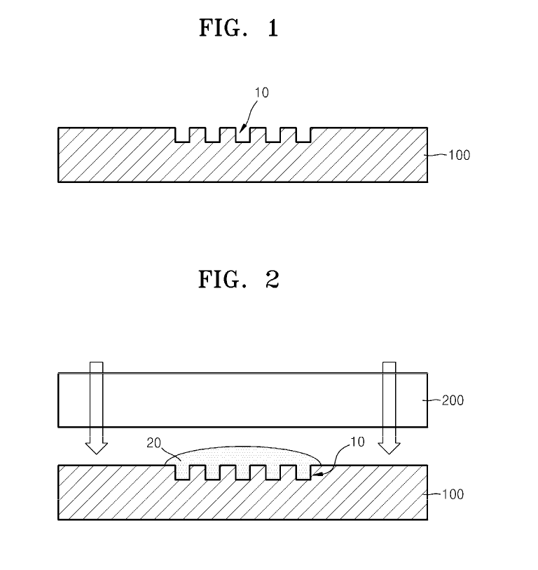

FIGS. 1 through 4 are cross-sectional views illustrating a method of manufacturing a stamp for nanoimprinting using the organic-inorganic hybrid material according to an example embodiment.

Referring to FIG. 1, a master mold 100 having a concave-convex structure 10 on an upper surface thereof is provided. The master mold 100 may be formed of, for example, silicon. The material and shape of the master mold 100 may be modified in various ways.

Referring to FIG. 2, the concave-convex structure 10 of the master mold 100 may be coated with a precursor 20. The precursor 20 may include the organic-inorganic hybrid material according to an example embodiment described with reference to Table 1. The precursor 20 may have a viscosity of about 500 cps or smaller, for example, about 10 cps or lower. A supporting plate 200 may be placed above the master mold 100. The supporting plate 200 may be formed of a stiff material through which UV rays are transmitted. For example, the supporting plate 200 may be formed of glass or quartz. However, the material of the supporting plate 200 is not limited thereto, and may be any of other various materials.

The precursor 20 may be pressed by the supporting plate 200. The pressing strength of the supporting plate 200 to the precursor 20 may be adjusted properly. In order to increase the adhesive force between the supporting plate 200 and the precursor 20, a lower surface of the supporting plate 200 may be treated with oxygen plasma or with UV/ozone before the pressing. Alternatively, the lower surface of the supporting plate 200 may be coated with an adhesion promoter. For example, a silane coupling agent may be used as the adhesion promoter.

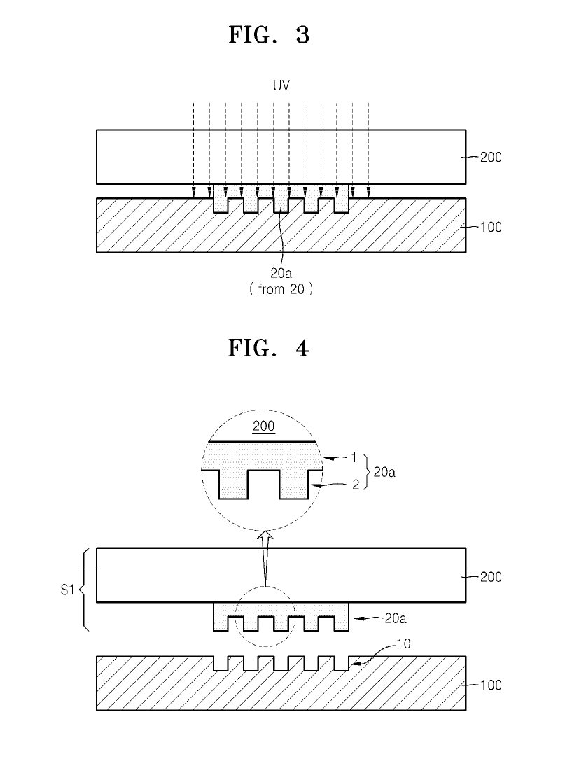

Referring to FIG. 3, the precursor 20 may be hardened by UV rays to form a hardened fine concave-convex structure 20a therefrom. The photoinitiator included in the precursor 20 may utilize the UV rays to cross-link molecules or atoms of the backbone material and the release material of the precursor 20, thereby forming the hardened fine concave-convex structure 20a. Organic-based materials of the related art such as PDMS are heat-hardening materials. Thus, patterns may deform due to a difference in thermal expansion coefficients between the master mold and the patterns during a heat hardening process. However, according to the example embodiment, since the fine concave-convex structure 20a is formed using a UV hardening process, problems related to heat hardening may be prevented or reduced.

Referring to FIG. 4, the supporting plate 200 to which the fine concave-convex structure 20a is attached may be separated from the master mold 100. The supporting plate 200 to which the fine concave-convex structure 20a is attached may be called a stamp S1 for nanoimprinting. The fine concave-convex structure 20a that is hardened by UV rays in the operation described with reference to FIG. 3 may have an elastic modulus of about 0.5 GPa or higher, for example, about 1 GPa or higher. Accordingly, when separating the stamp S1 of FIG. 4 from the master mold 100, the fine concave-convex structure 20a may be more easily separated without any deformation. Meanwhile, a UV transmittance of the fine concave-convex structure 20a is about 60% or greater, for example, 80% or greater, and a water contact angle thereof may be about 90° or greater. In addition, a thermal expansion coefficient of the fine concave-convex structure 20a may be about 10 ppm/K or smaller, for example, 1 ppm/K or smaller.

The stamp S1 having the fine concave-convex structure 20a may be used in a nanoimprinting process. The nanoimprinting process may be a UV nanoimprinting lithography (UV-NIL) process in which an UV-hardening type resin is used. However, alternatively, the stamp S1 may also be used in a thermal NIL process in which a heat-hardening type resin is used.

Referring to an expanded diagram of FIG. 4, the fine concave-convex structure 20a may include a buffer layer 1 and a pattern layer 2. The buffer layer 1 is interposed between the supporting plate 200 and the pattern layer 2, and may contribute to conformal contact between the stamp S1 and a resin layer during the nanoimprinting process. When the buffer layer 1 is too thick, shrinkage deformation of the pattern may increase, and thus the buffer layer 1 may be relatively thin. For example, the buffer layer 1 may have a thickness of about 10 μm or smaller, for example, about 100 nm or smaller. If the buffer layer 1 is thinner, the shrinkage deformation of the pattern layer 2 may be reduced further. The pattern layer 2 is a layer in which the concave-convex structure 10 of the master mold 100 is duplicated (transferred), having a pattern to be transferred in a predetermined or given resin layer during a nanoimprinting process, that is, a target pattern. The pattern layer 2 is illustrated for convenience but may have any of other various forms. For example, the pattern layer 2 may have a complex three-dimensional structure or may include, according to circumstances, curved surfaces.

While example embodiments have been particularly shown and described, example embodiments should be considered in a descriptive sense only and not for purposes of limitation. For example, it will be understood by those skilled in the art that various changes in form and details of the organic-inorganic hybrid material described with reference to Table 1 may be made. That is, other materials having similar properties as those shown in Table 1 may be used for the organic-inorganic hybrid material. Also, the method illustrated in FIGS. 1 through 4 and the resultant product thereof (the stamp S1 of FIG. 4) may be modified in various ways. In addition, the organic-inorganic hybrid material according to an example embodiment may also be applied to other fields in addition to the stamps for nanoimprinting. Therefore, the scope is defined not by the detailed description of example embodiments but by the appended claims.

What is claimed is:

1. An organic-inorganic hybrid material comprising:
a backbone material made of an inorganic material;
a release material; and
a photoinitiator,
wherein at least one of the release material and the photoinitiator is formed of an organic material.

2. The organic-inorganic hybrid material of claim 1, wherein the inorganic material of the backbone material is a compound including at least one selected from the group consisting of Si, In, Zn, Al, and Ti.

3. The organic-inorganic hybrid material of claim 2, wherein the compound is an oxide or a nitride.

4. The organic-inorganic hybrid material of claim 1, wherein the release material includes at least one selected from the group consisting of alkyl (CₙH₂ₙ₊₁), C, F, and Si.

5. The organic-inorganic hybrid material of claim 1, wherein the photoinitiator includes a material that provides ultraviolet (UV)-hardening characteristics to the organic-inorganic hybrid material.

6. The organic-inorganic hybrid material of claim 1, wherein the organic-inorganic hybrid material is an inorganic-based material including more inorganic material than organic material.

7. The organic-inorganic hybrid material of claim 1, wherein the organic-inorganic hybrid material has a viscosity of about 500 cps or smaller.

8. A stamp for nanoimprinting, comprising:
a fine concave-convex structure formed of the organic-inorganic hybrid material of claim 1; and
a supporting plate supporting the fine concave-convex structure.

9. The stamp of claim 8, wherein the fine concave-convex structure has an elastic modulus of about 0.5 GPa or greater.

10. The stamp of claim 8, wherein the fine concave-convex structure has a water contact angle of about 90° or greater.

11. The stamp of claim 8, wherein the fine concave-convex structure has an ultraviolet (UV) transmittance of about 60% or greater.

12. The stamp of claim 8, wherein the fine concave-convex structure includes a buffer layer and a pattern layer, and the buffer layer is between the supporting plate and the pattern layer.

13. A method of manufacturing a stamp for nanoimprinting, the method comprising:
coating a master mold having a concave-convex shape with a precursor, the precursor including an organic-inorganic hybrid material having a backbone material made of an inorganic material, a release material and a photoinitiator, at least one of the release material and the photoinitiator being formed of an organic material;
pressing the precursor with a supporting plate;
forming a fine concave-convex structure including,
transferring the concave-convex shape of the master mold to the precursor, and
hardening the precursor; and
separating the fine concave-convex structure attached to the supporting plate from the master mold.

14. The method of claim 13, wherein the hardening the precursor includes exposing the precursor to UV rays.
